(19) United States
(12) Patent Application Publication
(10) Pub. No.: US 2006/0174891 A1
(43) Pub. Date: Aug. 10, 2006

(54) Neonatal breathing device and method

(76) Inventor: Shari Rae Ammann, Yonkers, NY (US)

Correspondence Address: HOFFMANN & BARON, LLP, 6900 JERICHO TURNPIKE, SYOSSET, NY, 11791, US

(21) Appl. No.: 11/054,768

(22) Filed: Feb. 10, 2005

(51) Int. Cl. A62B 18/08; A62B 18/02

(52) U.S. Cl. 128/207.11; 128/207.13; 128/206.27; 128/207.18; 128/207.17

(57) ABSTRACT

A method for delivering respiratory gases to a neonatal infant includes the steps of providing a source of air or oxygen-rich respiratory gas through at least one nasal cavity of a neonatal infant; providing an elongate strap device having opposed ends securable to one and the other; positioning the elongate strap over the head and at or underneath a chin of the neonatal infant; and securing the opposed ends of the elongate strap so that the mouth of the neonatal infant remains closed while administrating the respiratory gas. The elongate strap device is useful as a neonatal breathing device holder. The holder includes a first elongate strap member releasably fitable over a head of a patient and underneath or at a chin of the patient; a chin-engaging portion slidably secured to the first elongate strap member, the chin-engaging portion being fitable over a chin of a patient; and securement means for securing a manifold for delivery of oxygen gas or oxygen-rich gas to the patient.

### FIELD OF THE INVENTION

The present invention is directed an improved method for delivering inspiratory gas to a neonatal infant and devices for the same. More particularly, the present invention is directed to a method and a device for closure of the neonate's mouth or lips to prevent loss of inspiratory gas during respiratory treatment.

### BACKGROUND OF THE INVENTION

Continuous positive airway pressure (CPAP) therapy involves applying positive pressure to the airway of a spontaneously breathing patient. It works, in the treatment of patients with unstable lung mechanics, by maintaining inspiratory and expiratory pressures at levels that are above ambient pressure. Neonatal applications of CPAP include the oxygenation of the neonate's lungs for the treatment of, among other things, respiratory distress syndrome and transient tachypnea of the newborn.

One system for neonatal CPAP includes the delivery of respiratory gasses through the nasal cavities of the neonate. Air and/or oxygen-rich air is typically delivered through nasal prongs fitable into the nasal cavities of the neonate.

One problem with such a technique is that the neonatal infant may be breathing while having the lips parted, i.e., an open mouth. In such a case the inspiratory gas may not reach the desired location, i.e. the neonate's lungs. Increasing the inspiratory gas pressure does not alleviate the problem as inspiratory gas will exit through the open mouth despite increased delivery pressure of the inspiratory gas.

### SUMMARY OF THE INVENTION

In one aspect of the present invention, a neonatal breathing device holder is provided. The holder comprises a first elongate strap member releasably fitable over a head of a patient and underneath or at a chin of the patient; a chin-engaging portion slidably secured to the first elongate strap member, the chin-engaging portion being fitable over a chin of a patient; a second elongate strap member releasably fitable around the rear portion of the head of the patient and secured to the first strap member; and securement means for securing a manifold for delivery of air or oxygen-rich gas to the patient.

The manifold desirably includes at least one tube fitable into a nasal cavity of the patent and a detent where the securement means is releasably secured to the detent. Desirably, the securement means is attached to the first elongate strap member. Desirably, the securement means comprises an elongate strap.

In one aspect of the present invention, the first strap member comprises opposed first and second surfaces, wherein the first opposed surface comprises a soft fabric surface, such as is a knitted textile surface, for positioning against the skin of the patient and the second opposed surface comprises a portion comprising an opposed raised-loop textile surface and a portion comprising a raised-hook fastener surface for releasably securing the raised-loop textile portion to the raised-hook fastener portion. Desirably, the raised-loop surface comprises raised polymeric filaments.

In another aspect of the present invention, the holder may further include a soft foam substrate disposed between the soft fabric surface and the raised-loop surface.

Desirably, the patient is a neonatal infant, but the device may be used for any patient in need of such therapy.

In another aspect of the present invention, a neonatal breathing device holder is provided. The holder comprises a first elongate strap member releasably fitable over a head of a patient and underneath or at a chin of the patient; and a chin-engaging portion slidably secured to the first elongate strap member, the chin-engaging portion being fitable over a chin of a patient. The holder may further comprise a securement means for securing a manifold for delivery of air or oxygen-rich gas to the patient. The holder may further comprise a second elongate strap member releasably fitable around the rear portion of the head of the patient and secured to the first strap member. Further, the first strap member may comprise opposed first and second surfaces, wherein the first opposed surface comprises a soft fabric surface for positioning against the skin of the patient and the second opposed surface comprises a portion comprising an opposed raised-loop textile surface and a portion comprising a raised-hook fastener surface for releasably securing the raised-loop textile portion to the raised-hook fastener portion. Moreover, the holder may further include a soft foam substrate disposed between the first and the second opposed surfaces.

In another aspect of the present invention, a method for delivering respiratory gases to a neonatal infant is provided. The method comprises the steps of providing a source of air or oxygen-rich respiratory gas through at least one nasal cavity of a neonatal infant; providing an elongate strap device having opposed ends securable to one and the other; positioning the elongate strap over the head and at or underneath a chin of the neonatal infant; and securing the opposed ends of the elongate strap so that the mouth of the neonatal infant remains closed while administrating the respiratory gas. The method may further comprise the steps of providing a manifold for delivery of the respirator gas to the neonatal infant; and releasably securing the manifold to the elongate strap.

Desirably, the step of positioning the elongate strap over the head and at or underneath a chin of the neonatal infant further comprises the steps of providing a chin-engaging member slidably secured to the elongate strap; and fitting the chin-engaging member over a chin of the neonatal infant.

### BRIEF DESCRIPTION OF THE DRAWINGS

FIG. 1 is a perspective view of a device, such as a strap, useful for assisting neonatal infants with oxygen delivery according to the present invention.

FIG. 2 is a cross-sectional view of the device of FIG. I taken along the 2-2 axis.

FIG. 3 is side elevational view of a raised-loop-and-hook-fastener useful with the present invention.

FIG. 4 is a perspective view of a chin-engaging member according to the present invention.

FIG. 5 is a top view of the member of FIG. 4 taken along the 5-5 axis.

FIG. 6 is a cross-sectional view of the member of FIG. 5 taken along the 6-6 axis.

FIG. 7 is a top view of the chin-engaging member of FIG. 4 being slidably positionable along the length of the device of FIG. 1.

FIG. 8 is a top view of the device of FIG. 1 further detailing a fastener for releasably securing opposed ends of the device.

FIG. 9 is a cross-sectional view of the fastener of FIG. 8 taken along the 9-9 axis.

FIG. 10 is a top view of the device of FIG. 8 further including a traversing elongate strap member.

FIG. 11 is a perspective view of the device of FIG. 8 according to the present invention.

FIG. 12 is a front view of a neonatal infant.

FIG. 13 is a front view of the neonatal infant of FIG. 12 having the device according to the present invention releasably secured to the infant and releasably secured to a portion of a neonatal breathing apparatus.

FIG. 14 is front view of a portion of the breathing device of FIG. 13 depicting nasal prongs for nasal ingress and egress of respiratory gas.

### DETAILED DESCRIPTION OF THE INVENTION:

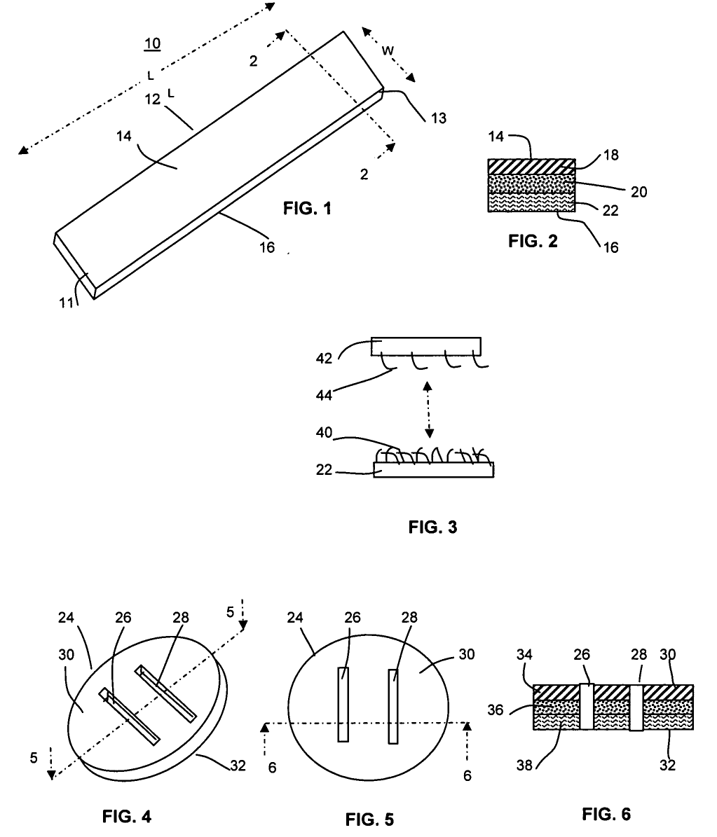

FIG. 1 is a perspective view of the neonatal breathing device 10 of the present invention. The device 10 is depicted as an elongate strip or strap 12 having a skin-contacting or interior surface 14, an opposed exterior surface 16, and opposed ends 11, 13. The length (L) and width (W) of the strap 12 may be any suitable length for fitting the strap over the head and under the chin of an infant, for example a neonatal baby. As a non-limiting example, the length (L) may vary from about 6 inches to about 24 inches, desirably from about 8 inches to about 14 inches. As a non-limiting example, the width (W) may vary from about 0.5 inches to about 2 inches, desirably from about 0.75 inches to about 1.25 inches. The length (L) and width (W) of the strap 12 of the present invention is based, inter alia, on ease of handling the device by a practitioner, nurse and the like; comfort to the patient, i.e., the neonatal infant; the ability to comfortably maintain the jaws, mouth and/or lips of the patient closed; and the ability to secure the air, oxygen or oxygen-rich delivery device, tubing, manifold and the like.

As depicted in FIG. 2, which is a cross-sectional view of the strap 12 of FIG. 1 taken along the 2-2 axis, the strap 12 may include different layers. For example, the skin-contacting surface 14 may include a soft textile layer 18, and the exterior surface 16 may include a backing layer 22. Optionally, an intermediate layer 20 may be disposed between the soft textile layer 18 and the backing layer 22.

The soft textile layer 18 may desirably be soft and non-irritating to the skin of the neonatal infant. The textile layer 18 may be made from any suitable textile pattern, for example, a woven pattern, a knitted pattern, a braided pattern, and the like and combinations thereof. Desirably, the textile pattern is a knitted pattern, as a knitted pattern often has structural flexibility among interlooping yarns to provide, inter alia, comfort while the strap 12 is securably disposed over the neonatal infant. The textile pattern may include natural yarns, such as cotton or silk yarns, or polymeric yarns, such as polyester or polyamide yarns. Desirably, the yarns are cotton yarns which are soft, non-irritating and absorbent of fluids or moisture.

The backing layer 22 may be of any textile or polymeric design. The backing layer 22 provides, inter alia, support for the more flexible skin-contacting layer 18. Desirably, the backing layer 22 includes a pattern of raised filament yarns 40, which are depicted in FIG. 3. The raised yams 40 may be any suitable yams having sufficient stiffness and resiliency, for example raised polymeric yams, desirably polyamide yams. As depicted in FIG. 3, the raised filament yams 40 of the backing layer 22 may releasably engage raised hooks 44 of a fastener member 42. Such a raised-loop-and-hook-fastener system advantageously allows for releasable securement of the backing layer 22 to the fastener member 42 without need for the use of adhesives. Such a raised-loop-and-hook-fastener system is also commonly known as a Velcro® fastener.

The optional intermediate layer 20, which as depicted in FIG. 2 may be disposed between the soft textile layer 18 and the backing layer 22, may be optionally provided for absorbency and comfort. Desirably, the intermediate layer 20 may be a foamed polymeric layer. The skin-contacting layer 18 and the backing layer 22, and optionally the intermediate layer 20, are securably joined to form a unitary structure. These layers may be joined together through heat bonding and/or through chemical means, such as through the use of adhesives.

FIGS. 4 and 5 depict a slidable chin-engaging portion 24 of the present invention. The chin-engaging portion 24 is depicted as being substantially circular. The present invention, however, is not so limited to a substantial circular shape, and other shaped portions, such as rectangular, elliptical, cupped-shaped, and the like, may suitably be used. The chin-engaging portion 24 includes a skin-contacting surface 30 and an opposed exterior surface 32. The chin-engaging portion 24 further includes two elongate, narrow slits or slots 26, 28. As depicted in FIG. 6, which is a cross-sectional view of the chin-engaging portion 24, the chin-engaging portion 24 may include a soft textile layer 34, a backing layer 38 and optionally an intermediate layer 36. The soft textile layer 34, the intermediate layer 36 and the backing layer 38 may be the same or different as the above-described textile layer 18, intermediate layer 20 and backing layer 22, respectively.

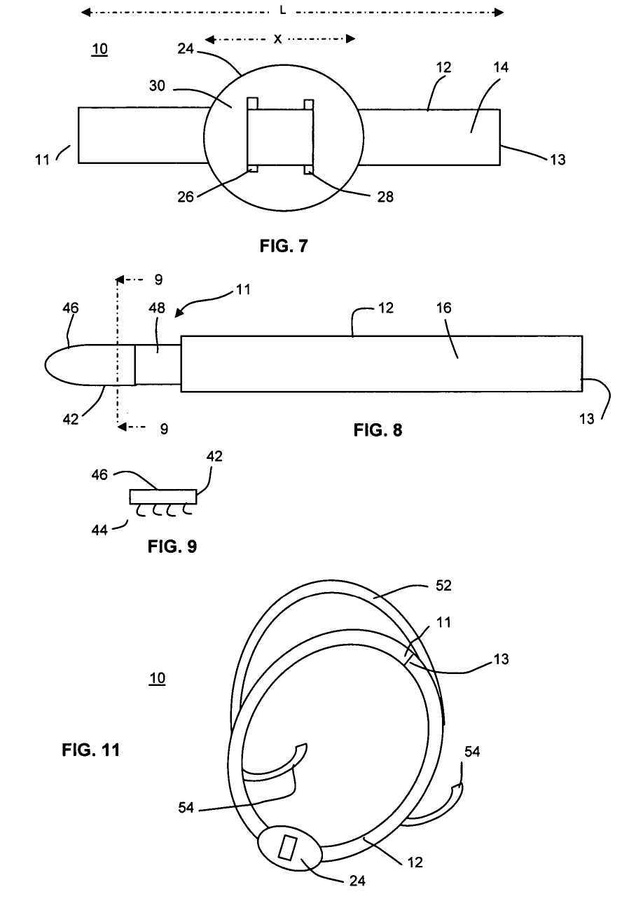

A top planar view of the device 10 of the present invention showing the skin-contacting surfaces, i.e., the soft textile layers 18 and 34, of the different elements 12, 24 of the present invention is depicted in FIG. 7. Desirably, the strap 12 is disposed over the portion of the chin-engaging member 24 located between the two elongate slots 26, 28, and underneath the portions of the chin-engaging member 24 extending from the slots 26, 28 to the end or edge of the member 24. With such an arrangement, the chin-engaging member 24 tends to contour to the chin of a patient, for example a neonate, in a cupped fashion (not shown) to provide enhanced securement and comfort. In other words, the soft skin contacting surfaces 18, 34 of the present invention are cupped at the neonate's chin after securement of the device 10 thereon. The present invention, however, is not so limited, and other configurations may suitably be used. For example, the strap 12 may be slid through the slots 26, 28 so that the strap is underneath the portion of the chin-engaging member 24 between the slots 26, 28. Moreover, the present invention is not limited to the use of just two slots 26, 28, and any other useful number of slots or other means for providing sliding engagement of the strap 12 and the chin engaging member 24 may suitably be used. Moreover, as depicted in FIG. 7 by the vector “X”, the chin-engaging portion 24 is slidably moveable along the length (L) of the strap 12. Such slidable movement allows for fast and comfortable adjustment of the device 10 of the preset invention at or underneath the chin of the neonate or patient.

Additional details of the strap 12 of the present invention are depicted in FIG. 8. A fastener member 42 may be secured to one end of the strap 12. The fastener 42 may be directly connected to the strap 12 by any convenient means, for example by sewing. Alternatively, the fastener member 42 may be connected to a textile portion 48, and the textile portion 48 may be then connected to the strap 12. The fastener member 42, the textile portion 48 and the strap 12 may be suitably connected by any convenient means, for example by sewing. Desirably, the textile portion 48 has longitudinal flexibility such that the fastener 42 may be pulled away from the strap 12 to provide appropriate tension to the strap 12 as it is being secured to the neonatal patient. One non-limiting example of an elastic textile portion 48 is a woven textile pattern having expandable yarns extending along the direction of the desired expansion.

As depicted in FIGS. 8 and 9, the raise hooks 44 of the fastener 42 are opposed from the raised filaments 40 (not shown) of exterior surface 22. In other words as depicted in FIGS. 8 and 9, the raised hooks 44 of the fastener 42 are on the underside of the strap 12 and the exterior surface 16 having the raised filaments 40 (not shown) are on the top-side of the strap 12. Desirably, when the strap 12 is formed into a loop, the raised hooks 44 of the fastener 42 engage to the raised filaments 40 of the exterior surface 16 of the strap 12 to allow for releasable securement over the head and at or underneath the chin of the neonatal patient. Further as depicted in FIG. 9, the fastener 42 has a smooth or non-irritating surface 46 opposed from the surface containing the raised hooks 44.

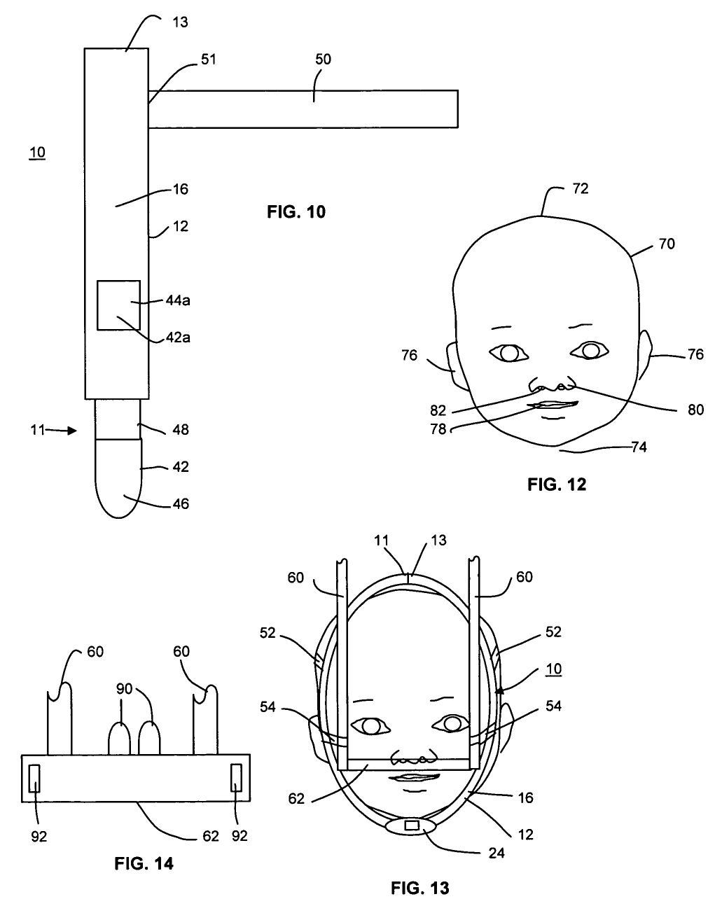

As depicted in FIG. 10, the device 10 of the present invention may further include an elongate member 50 secured to a portion 51 of the strap 12. The member 50 may be of the same design of the strap 12, i.e., having the skin-contacting layer 18, the optional intermediate layer 20 and exterior layer 22, or may be different, for example having only the skin-contacting layer 18 or the exterior layer 22. Further, the present invention is not limited to a single elongate strap member 50 being traversingly secured to the strap 12, and multiple elongate strap members, for example members 52 and 54 as described below, may be suitably fastened to the elongate strap 12. Also as depicted in FIG. 10, the strap 12 may have a fastener 42a with the raised hooks 44a (not shown) disposed upon the exterior surface 16 of the strap 12. Such a fastener 42a may securably engage the elongate member or strap 12 via the raised filaments 40 along the exterior surface 16 to provide a securement loop traverse to the loop formed by the strap 12 itself. As described below, such a securement loop may be useful for placement around the head of the patient.

FIG. 11 is a perspective view of the device 10 of the present invention where the opposed ends 11, 13 of the strap 12 are releasably secured to one and the other by the above-described fastener means. As depicted in FIG. 11 the strap 12 may be formed into a loop with the chin-engaging member 24 being slidably positional along the length of the strap 12. An optional elongate strap 52 may be formed into a second loop which, as depicted in FIG. 11, is in a different plane from the plane formed by the loop of strap 12. As described below, the loop formed by the elongate strap 52 may be placed around the back of the head of a neonate to further aid in securement of the device 10 of the present invention. Additionally, elongate members 54 may also optionally be secured to the strap 12. Such members 54 may be used for securement of the breathing apparatus or a portion of the breathing apparatus to the device 10 of the present invention.

A front view of a neonatal infant 70 is depicted in FIG. 12. The neonatal infant 70 has a top of the head portion 72, ears 76, a chin 74, a nose 80 with nasal cavities 82, and a mouth 78, interrelated as shown.

As depicted in FIG. 13, the device 10 of the present invention may optionally secure a portion of the breathing apparatus, for example tubes 60, through engagement with elongate members 54. In other words, the elongate members 54 may be looped over and releasably secured to the tubes 60 to further assist in the administration of the respiratory therapy. The present invention, however, is not limited to the securement of the elongate members 54 over the tubes 60, and other techniques may suitably be used. For example, the tubes 60 may be provided with detents (not shown), such as, but not limited to, protrusions, such as slotted protrusions, to the elongate members 52 may be releasably secured.

As depicted in FIG. 13, the ends 11, 13 of the strap 12 are desirably secured to one and the other at a location proximal to the top of the head 70 of the neonatal infant 70. The present invention, however, is not so limited, and the ends 11, 13 may be secured at other locations around the neonatal infant 70, for example towards one side of the neonate 70 at, below or above locations proximal to the one of the ears 76. Further, as depicted in FIG. 13, the strap 12 is depicted as being releasably secured over the head 72 of the neonate 70 with the chin-engaging member 24 being disposed at or underneath the chin 74 of the neonate. Elongate member 52 may be placed around the back of the head of the neonate, typically over the ears 76, to further assist in the proper placement and securement of the breathing apparatus and of the device 10 of the present invention.

As depicted in FIG. 13, the tubes 60 are in fluid communication with the neonatal infant 70 via a manifold 62. Typically, one the tubes 60 is used for inspiration and the other tube 60 is used for expiration of respiratory gas.

FIG. 14 depicts a portion of the manifold 62. Typically, the manifold 62 may include two prongs 90 or has connections for the two prongs 90. The prongs 90 are desirably fitable into the nasal cavities 82 of the neonate 70. Optionally, the manifold 62 may include detents 92. In such a case, the elongate members 54 of device 10 may be releasably secured to the detents 92 of the manifold 62. Such optional securement may be in addition to or in place of the above-described securement of the elongate members 54 to the tubes 60. While the detents 92 are depicted as slots in FIG. 14, the invention is not so limited and other suitable notches or protrusions may suitably be used.

Various other modifications to the foregoing disclosed embodiments will now be evident to those skilled in the art. Thus, the particularly described embodiments are intended to be illustrative and not limited thereto. The true scope of the invention is set forth in the following claims.

1. A neonatal breathing device holder comprising:
a first elongate strap member releasably fitable over a head of a patient and underneath or at a chin of the patient;
a chin-engaging portion slidably secured to the first elongate strap member, the chin-engaging portion being fitable over a chin of a patient;
a second elongate strap member releasably fitable as a loop around the rear portion of the head of the patient and secured to the first strap member; and
securement means for securing a manifold for delivery of air or oxygen-rich gas to the patient, wherein the securement means is attached to the first elongate strap member.

2. The holder of claim 1, wherein the manifold comprises at least one tube fitable into a nasal cavity of the patent.

3. The holder of claim 1, wherein the manifold comprises a detent and the securement means is releasably secured to the detent.

4. (canceled)

5. The holder of claim 1, wherein the securement means comprises an elongate strap.

6. The holder of claim 1, wherein the first strap member comprises opposed first and second surfaces, wherein the first opposed surface comprises a soft fabric surface for positioning against skin of the patient and the second opposed surface comprises a portion comprising an opposed raised-loop textile surface and a portion comprising a raised-hook fastener surface for releasably securing the raised-loop textile portion to the raised-hook fastener portion.

7. The holder of claim 6, wherein the raised-loop and fabric surface and the raised-hook fastener surface is a Velcro® fastener.

8. The holder of claim 6, wherein the soft fabric surface is a knitted textile surface.

9. The holder of claim 6, wherein the raised-loop surface comprises raised polymeric filaments.

10. The holder of claim 6, further including a soft foam substrate disposed between the soft fabric surface and the raised-loop surface.

11. The holder of claim 1, wherein the patient is a neonatal infant.

12. A neonatal breathing device holder comprising:
a first elongate strap member releasably fitable over a head of a patient and underneath or at a chin of the patient; and
a chin-engaging portion slidably secured to the first elongate strap member, the chin-engaging portion being fitable over a chin of a patient; wherein the first strap member comprises opposed first and second surfaces and a soft foam substrate disposed between the first and the second opposed surfaces wherein the first opposed surface comprises a soft fabric surface for positioning against skin of the patient and the second opposed surface comprises a portion comprising an opposed raised-loop textile surface and a portion comprising a raised-hook fastener surface for releasably securing the raised-loop textile portion to the raised-hook fastener portion.

13. The holder of claim 12, wherein the patient is a neonatal infant.

14. The holder of claim 12, further comprising:
securement means for securing a manifold for delivery of air or oxygen-rich gas to the patient.

15. The holder of claim 12, further comprising a second elongate strap member releasably fitable around the rear portion of the head of the patient and secured to the first strap member.

16-17. (canceled)

18. A method for delivering respiratory gases to a neonatal infant comprising:
providing a source of air or oxygen-rich respiratory gas through at least one nasal cavity of a neonatal infant;
providing an elongate strap device having opposed ends securable to one and the other;
positioning the elongate strap over the head and at or underneath a chin of the neonatal infant; and
securing the opposed ends of the elongate strap to one and the other so that the mouth of the neonatal infant remains closed while administrating the respiratory gas.

19. The method of claim 18, further comprising:
providing a manifold for delivery of the respirator gas to the neonatal infant; and
releasably securing the manifold to the elongate strap.

20. The method of claim 18, wherein the step of positioning the elongate strap over the head and at or underneath a chin of the neonatal infant further comprises:
providing a chin-engaging member slidably secured to the elongate strap; and
fitting the chin-engaging member over a chin of the neonatal infant.

21. The method of claim 20, wherein the step of fitting the chin-engaging member over a chin of the neonatal infant includes sliding the chin-engaging member over the chin of the neonatal infant.

22. The method of claim 20, wherein the step of fitting the chin-engaging member over a chin of the neonatal infant includes contouring the chin-engaging member to the chin of the neonatal infant

23. The holder of claim 1, wherein the first elongate strap member comprises opposed first and second surfaces and a soft foam substrate disposed between the first and the second opposed surfaces, wherein the first opposed surface comprises a soft fabric surface for positioning against skin of the patient and the second opposed surface comprises a portion comprising an opposed raised-loop textile surface and a portion comprising a raised-hook fastener surface for releasably securing the raised-loop textile portion to the raised-hook fastener portion.
